(19) United States
(12) Patent Application Publication
(10) Pub. No.: US 2019/0382924 A1
(43) Pub. Date: Dec. 19, 2019

(54) NYLON BASED MATERIALS, FILAMENTS, AND FABRICS AND ASSOCIATED METHODS

(71) Applicant: Shakespeare Company, LLC, Boca Raton, FL (US)

(72) Inventor: Saumitra Bhargava, Clarksville, MD (US)

(21) Appl. No.: 16/380,574

(22) Filed: Apr. 10, 2019

Related U.S. Application Data
(60) Provisional application No. 62/686,983, filed on Jun. 19, 2018.

(51) Int. Cl. D01F 6/90; C08G 69/26

(52) U.S. Cl. CPC D01F 6/90; D02G 3/38; D10B 2331/02; C08G 69/26

(57) ABSTRACT

Improved nylon 6,10 materials, methods of making the same, and filaments and fabrics made from the improved nylon 6,10 materials are provided herein.

### CROSS-REFERENCE TO RELATED APPLICATIONS

This application claims the benefit of priority to U.S. Provisional Patent Application No. 62/686,983, filed on Jun. 19, 2018, which is incorporated herein by reference in its entirety.

### BACKGROUND

The present application relates generally to nylon based materials, filaments, yarns, and fabrics, as well as associated methods of product and/or use thereof, and relates more specifically to nylon based filaments and materials formed from nylon 6,10 or similar nylon materials.

Polyester fabrics currently dominate the activewear market and are becoming popular in mainstream clothing fabrics, because of their resistance to wrinkling and low-moisture uptake. Meanwhile, relative to polyester fabrics, nylon fabrics offer lower coefficient of friction, dramatically reduced wear, lower propensity to generate static, and improved feel, but suffer from wrinkling and dimensional changes when wet. Moreover, polyester fabrics suffer from odor buildup because the material promotes the growth of odor-causing bacteria.

Thus, there is a need for filaments, yarns, and fabrics having the beneficial properties of nylon with improved properties such as improved resistance to wrinkling, dimensional changes, and odor.

### SUMMARY

This summary is provided to introduce various concepts in a simplified form that are further described below in the detailed description. This summary is not intended to identify required or essential features of the claimed subject matter nor is the summary intended to limit the scope of the claimed subject matter.

In one aspect, a method of making a nylon 6,10 material is provided, including conducting a polymerization reaction to obtain a nylon 6,10 material having a relative viscosity of from about 40 to about 70.

In another aspect, a nylon 6,10 material having a relative viscosity of from about 40 to about 70 is provided.

In another aspect, a filament is provided including a main structural component that comprises a nylon material selected from nylon 6,10, nylon 6,12, nylon 6,18, nylon 11, nylon 12, and copolymers of nylon 6,10, nylon 6,12, nylon 6,18, nylon 11, and nylon 12, wherein the filament has a denier per filament of from about 0.7 dpf to about 4 dpf, and wherein the filament displays a reduction of microfiber generation, by weight, over 30 wash cycles, as compared to an otherwise equivalent polyethylene terephthalate (PET) filament.

In some aspects, the nylon 6,10 material has a crystallization peak range of at least about 15° C. In some aspects, carboxylic acid end groups exceed amino end groups in the nylon 6,10 material. In some aspects, a filament including the nylon 6,10 material is provided. In some aspects, a fabric including the nylon 6,10 material is provided.

This summary and the following detailed description provide examples and are explanatory only of the invention. Accordingly, the foregoing summary and the following detailed description should not be considered to be restrictive. Additional features or variations thereof can be provided in addition to those set forth herein, such as for example, various feature combinations and sub-combinations of these described in the detailed description.

### DETAILED DESCRIPTION

Nylon based filaments and yarns and fabrics made therefrom are disclosed herein, along with methods and materials for manufacturing the same. The nylon-based filaments possess one or more improved properties as compared to known nylon filaments and/or known apparel filaments, such as polyester filaments. In particular, embodiments of the nylon filaments and yarns disclosed herein may display one or more of: improved tenacity, resistance to wrinkling, resistance to odor causing bacteria, and resistance to dimensional changes when wet as compared to otherwise equivalent filaments formed from conventional nylon or polyester materials.

As used herein, the term “filament” is used broadly to refer to a thread or fiber-like structure, and refers generally to filaments that are monofilaments or multifilaments. For example, the filaments may be made in a typical extrusion process or other known process. As used herein, the term “multifilament” refers broadly to multifilament yarns or fibers in which a plurality of filaments are combined, such as in a typical yarn spinning process.

### Methods of Making Nylon Based Materials

In certain embodiments, methods of making a nylon 6,10 material are provided. For example, the method may include conducting a polymerization reaction to obtain the nylon 6,10 material. In some embodiments, conducting the polymerization reaction involves reacting sebacic acid and hexamethylenediamine. For example, the sebacic acid may be high purity sebacic acid. For example, the sebacic acid may have a purity of 95% or higher, such as about 99.5% purity.

In some embodiments, the reactants are filtered prior to conducting the polymerization reaction. For example, the reactants may be filtered through a filter having a filter size of 5 microns or smaller, such as a filter size of 3 microns or smaller.

It has been discovered that a nylon 6,10 material having a relative viscosity of from about 40 to about 70 provides improved processing and filament/yarn/fabric properties. As such, the polymerization reaction may be carried out to achieve such a viscosity range. In some embodiments, the nylon 6,10 material has a relative viscosity of from about 50 to about 60, such as from about 55 to about 58. As used herein, the term “about” is used to refer to plus or minus 5 percent of the numerical value of the number with which it is being used.

It has further been discovered that such nylon 6,10 materials may be produced in a polymerization reaction in the absence of a catalyst. For example, the nylon 6,10 materials may be produced in the absence of the phosphorous-based catalysts that are traditionally employed in such nylon production reactions. Without intending to be bound by a particular theory, it is believed that the absence of such catalysts influences the viscosity build of the nylon, allowing for the production of relatively high viscosity nylon materials, as compared to traditional nylon materials. Moreover, such methods beneficially yield nylon 6,10 materials that are free of residual catalyst materials.

It has also been discovered that a nylon 6,10 material having a relatively broad crystallization peak, which is indicative of slow crystallization, as compared to traditional nylon materials, yields improved processing and filament/yarn/fabric properties. As such, the purity of ingredients, lack of additives (e.g., catalysts), and appropriate viscosity may be selected to achieve such crystallization properties. For example, the nylon 6,10 material may be produced to have a crystallization peak range of at least about 15° C., such as from about 15° C. to about 20° C. For example, the nylon 6,10 material may display an onset of crystallization at a temperature of about 189° C., a peak crystallization at a temperature of about 179° C., and a crystallization end point at a temperature of about 171° C. In certain embodiments, the peak crystallization may occur at a temperature of 181° C. or lower.

In certain embodiments, the nylon 6,10 has carboxylic acid groups in excess of amine end groups. For example, the nylon 6,10 may have a carboxylic acid end group >30 meq/Kg. Without intending to be bound by a particular theory, it is believed that this results in improved odor control, as will be described in greater detail below.

Additionally, it has been discovered that nylon materials having smaller relative viscosity increases when held at their melt temperature provide improved processing and resulting filament/yarn/fabric properties. As such, the polymerization reaction may be carried out to achieve such a viscosity profile of the nylon material. For example, the nylon 6,10 material displays a viscosity increase of less than thirty percent over time when held at melt temperature.

Beneficially, the nylon 6,10 materials described herein may display one or more of these properties, which may help with processing and impart improved performance properties to filaments, yarns, and fabrics produced therefrom. For example, because nearly all commercial filament spinning machines are equipped with long transfer lines, which are needed to obtain uniformity end to end within a fabric, the presently described materials' ability to minimally change in viscosity during production beneficially avoids breaks in filaments formed from these materials during spinning processes.

In certain embodiments, these methods also include pelletizing the nylon 6,10 material to form pellets suitable for further processing.

While these methods have been described with reference to nylon 6,10, it is believed that other nylons, including nylon 6,12, nylon 6,18, nylon 11, nylon 12, and copolymers containing nylon 6,10, nylon 6,12, nylon 6,18, nylon 11, nylon 12, will result in many of the same desirable benefits. Thus, similar methods and materials incorporating these further nylons are also intended to fall within the scope of this disclosure.

### Nylon Based Materials

Nylon based materials, such as those produced from any of the above-described methods are also provided. For example, the nylon based materials may be produced to achieve any of the above-described properties.

In certain embodiments, a nylon 6,10 material has a relative viscosity of from about 40 to about 70, such as from about 50 to about 60, or from about 55 to about 58. Without intending to be bound by a particular theory, it is believed that nylon 6,10 materials having this relatively high relative viscosity range are better suited for spinning performance than other viscosities. This was unexpected as typical nylon 6 or nylon 6,6 materials used in spinning filaments have viscosities in the range of 32 to 45. However, it has surprisingly been found that nylon 6,10 materials having a higher relative viscosity, as measured by the method described in ASTM D789, such as in the range of about 40 to about 70, display improved processing parameters in partially oriented yarn (POY), medium oriented yarn (MOY), and fully drawn yarn (FDY) processing methods.

In certain embodiments, the nylon 6,10 material is free of any catalytic residue, such as any phosphorus-based catalytic residue. In certain embodiments, as described above, the nylon 6,10 material has a crystallization peak range of at least about 15° C., such as from about 15° C. to about 20° C. For example, the nylon 6,10 material may display an onset of crystallization at a temperature of about 189° C., a peak crystallization at a temperature of about 179° C., and/or a crystallization end point at a temperature of about 171° C.

In certain embodiments, the nylon 6,10 material displays a viscosity increase of less than thirty percent over time when held at melt temperature for 60 minutes.

In some embodiments, the nylon 6,10 material is in a pellet form.

### Methods of Making Filaments and Yarns

Methods of making filaments and yarns are also provided herein. In certain embodiments, the method includes spinning any of the nylon materials, such as nylon 6,10 materials, described herein to form a filament. For example, the spinning may include any suitable continuous or staple spinning process as are known in the industry. For example, the spinning may be a continuous process configured to produce a partially oriented yarn, a medium oriented yarn, or a fully drawn yarn. In some embodiments, the method includes spinning a filament from a nylon 6,10 material having a relative viscosity of from about 40 to about 70 to form a filament.

For example, any known filament extrusion, melt spinning process know in the art may be used. For example, a multifilament yarn may be made by a standard fully drawn yarn process, such as one that forms a continuous 34 filament 100 denier yarn. The filaments, yarns, and fabrics described herein may be textured or crimped, as desired for the particular application. This textured yarn may be knitted, tufted, or woven into a fabric. It can be dyed in yarn form or in a fabric form. Beneficially, the dye wash fastness and flexibility of coloration for nylon materials, such as the filaments described herein, is much greater than polyester.

In certain embodiments, a nylon 6,10 material is utilized in a staple fiber process in which the fiber is drawn, crimped (e.g., about 15 crimp per inch), and cut to a short length (e.g., from 1 to 1.5 inch, such as 38 mm). It has been determined that heated godets or heated chambers allow improved drawing during the heated draw/cut step for staple fibers formed from nylon 6,10 materials. Next the resulting staple fibers/filaments may be combined with other fibers/filaments to make a yarn. For example, the nylon 6,10 fibers can be blended in a staple form with nylon 6,6, nylon 6 or a nylon 6 copolymer staple fiber of similar length, dpf, and crimp to achieve dimensional stability.

In certain embodiments, the overall biobased content of the nylon 6,10 filaments produced by these methods is at least about 60 percent, by weight. Thus, these methods may involve more environmentally friendly polymer materials and spinning processes than the processes used for other athletic apparel filaments, such as Tencel and rayon, which are produced via solution spinning. Indeed, the yarn production described herein may involve melt spinning which has a significantly lower energy requirement than solution spinning. Moreover, the fabrics produced from these filaments can be recycled via the same melt spinning process.

### Filaments and Multifilament Yarns

Filaments and multifilament yarns produced from such filaments are also provided herein. For example, the filaments may be formed from any of the nylon based materials described herein, such as nylon based materials displaying the described crystallization and viscosity characteristics disclosed above. In certain embodiments, the filaments have a main structural component that includes the improved nylon materials disclosed herein. For example, the filament may contain a main structural component that includes a nylon material selected from nylon 6,10, nylon 6,12, nylon 6,18, nylon 11, nylon 12, and copolymers of nylon 6,10, nylon 6,12, nylon 6,18, nylon 11, and nylon 12, as described herein.

As used herein, the phrase “main structural component” refers to the polymer material that forms the bulk of the filament and provides the structural properties thereto. That is, any additive component, coating or finish, or other supplemental material combined with the main structural component to form the filament, does not significantly alter the structural properties of the filament imparted by the main structural component.

As used herein, the phrase “an additive component” refers to one or more suitable additive materials that are distinct from the polymer(s) forming the main structural component and that do not significantly alter the structural properties of the filament as imparted by the main structural component. The additive component is optional. For example, the additive component may be present in the composite material in an amount of up to about 3 percent, by weight. For example, the additive component may be present in the composite material in an amount of from about 0.1 percent, by weight, to about 3 percent, by weight. In certain embodiments, the additive component is present in the composite material in an amount of from about 0.1 percent, by weight, to about 1.5 percent, by weight.

The one or more materials of the additive component may be premixed with the nylon components or may be combined with the nylon components as a separate ingredient. For example, the additive component may include one or more additive materials selected from dyes, pigments, optical brighteners, stabilizers, such as UV stabilizers, antifoam agents, anti-static agents, antimicrobial agents, and mixtures thereof. For example, the additive materials may be selected from agents containing fumed silica, activated carbon or other species which are difficult to incorporate in filaments. Additionally, functional additives such as remediation or catalytic materials may be used. Other suitable additives are known in the filament processing industry and may also be used.

In some embodiments, a filament having a main structural component that is one of the nylon based materials, such as the nylon 6,10 based materials, described herein. In certain embodiments, the filament exhibits antibacterial surface properties that resist the presence of odor-causing bacteria, such as Staphylococcus, Propionibacterium acnes, and/or Micrococcus. Without intending to be bound by a particular theory, it is believed that the surface characteristics of the nylon based filaments described herein prevent the growth of such odor causing bacteria, without the presence of antimicrobial agents in the filament. Such benefit was unexpected because traditional materials from which filaments for apparel are formed are known for promoting odor causing bacteria. For example, the surface characteristics of nylon 6,6 base filaments are known to promote dominant bacteria Staphylococcus and Propionibacterium acnes (foot odor), while the surface characteristics of polyester based filaments are known to promote dominant bacteria Micrococcus, and the surface characteristics of cotton based filaments are known to promote dominant bacteria Staphylococcus (see AEM Accepts, published online ahead of print on 15 Aug. 2014 Appl. Environ. Microbiol. doi:10.1128/AEM.01422-14, American Society for Microbiology.) Indeed, it is known that traditional polyester based filaments are especially prone to heavy attraction of bacteria. Traditionally, elimination of bacteria from such known filament materials has involved addition of antimicrobial agents to the filaments; however, such agents may be undesirable for a variety of reasons, including complicating the polymer material/filament manufacturing processes, and their risk for causing environmental contamination.

In certain embodiments, the filaments described herein, including those formed from nylon 6,10, nylon 6,12, nylon 6,18, nylon 11, nylon 12, and copolymers containing nylon 6,10, nylon 6,12, nylon 6,18, nylon 11, nylon 12 (such as those disclosed in International Application No. WO2013/106817), are configured to display a reduction of microfiber generation, by weight, as compared to a PET filament having equivalent dimensions and hand. As used herein, the phrase “microfiber generation” refers to the filament releasing fibers having a length of 5 mm or less during laundering. Such microfiber pollution is released into the environment if wastewater treatment sludge is used as fertilizer. Thus, the presently disclosed fibers may display a reduction of microfiber generation of from about 50 percent to about 99 percent, as compared to an equivalent PET filament. For example, the reduction of microfiber generation may be from about 75 percent to about 90 percent.

For example, the microfiber generation may be tested by repeated laundering and ageing of samples. In particular, the weight change of the filament/fabric upon 30 cycles of washing and drying may be used to quantify the microfiber generation. In one experimental example, greater than 50 percent reduction in weight loss was observed when comparing the same specification for yarn and fabric, between the nylon 6,10 filaments disclosed herein and comparative PET based filaments. Further, with modified fabric and yarn specifications to match hand or softness of the PET fabrics, the nylon 6,10 fabrics exhibited 75 to 90 percent reduction in propensity for microfiber pollution.

As used herein, the term “hand” refers to the smoothness or roughness of a fabric. For example, in the apparel industry, a fabric is deemed to have a “soft hand” if it is smooth to the touch and something that they would imagine being a comfortable cloth to wear. Soft hand can also be referenced as a fine hand, as measured by AATCC Evaluation Procedure 5-2006—“Fabric Hand”. Thus, it was surprisingly found that filaments having similar soft hand properties as PET filaments could be manufactured to display significantly lower microfiber generation.

The filaments described herein may be formed to have any suitable dimensions and cross-sectional shape. For example, the filaments may have a round, trilobal, or any other suitable cross-sectional shape. In certain embodiments, the filaments have a denier per filament of from about 0.7 dpf to about 12 mil. For example, the filaments may have a denier per fiber of from about 0.1 dpf to about 4 dpf, such as from about 0.7 to about 3.5 dpf, such as about 1.2 dpf. For example, denier may be measured by the denier reel/balance or Statimat Autocount, per ASTM D1907M-12—“Standard Test Method for Linear Density of Yarn (Yarn Number) by the Skein Method”. For example, such filaments may be suitable for use in apparel fabrics.

### Fabrics

In certain embodiments, a fabric is provided that is formed from a multifilament (i.e., yarn) formed from one or more of the filaments described herein. The fabric may be constructed by any suitable means, including weaving or knitting. It is believed that fabrics formed from the filaments described herein may be manufactured to have improved fabric properties, including but not limited to improved wear performance, softness (i.e., hand), reduced skin abrasion (e.g., fiber surface is smoother, fabric dimension not changing when wet, easy to dry, moisture wicking, reduced static build-up, and improved wrinkle resistance.

In certain embodiments, a fabric is formed from a multifilament continuous or staple yarn formed from known processes. The fabrics and yarns described herein may be formed exclusively from the filaments described herein or may contain a combination of the filaments described herein and other nylon or other synthetic or natural filaments. For example, the filament may be a staple filament formed from staple fibers of the nylon 6,10 (or similar) material and staple fibers formed from another nylon material, such as nylon 6,6, nylon 6, and nylon 6 copolymers.

In certain embodiments, the fabric contains from about 30 percent to about 100 percent of filaments formed from the nylon 6,10 material, by weight. It has been determined that at least some of the improved performance properties described herein are detectable in a fabric containing at least about 30 percent of the nylon 6,10 material. For example, the remaining portion of the filaments forming the fabric may be selected from those formed from nylon 6,6, nylon 6, nylon 6 copolymers, cotton, PET, or a combination thereof.

In certain embodiments, the fabrics described herein do not contain an elastomer. It has surprisingly been found that fabrics made from the nylon 6,10 materials described herein display reduced skin-abrasion, as compared to otherwise equivalent polyester fabrics. Beneficially, avoiding the use of elastomers in the fabric may improve dye uniformity.

Traditionally, the abrasiveness of polyester yarns against skin is reduced by introducing an elastomer in the fabric to form a compression garment. The added elastomer makes the fabric adhere to skin and eliminates friction between skin and fabric. However, adding the elastomer limits the styling and color options of the fabric. Thus, warp knit and circular knit compression fabrics may be manufactured without an elastomer, using the nylon 6,10 materials described herein. In other embodiments, elastomeric filaments may be combined with the nylon 6,10 based filaments described herein.

In certain embodiments, the fabrics described herein display a dimensional change when wet of less than 1 percent, per length. For example, an example embodiment in which the nylon 6,10 staple fiber filaments described herein were mixed with staple fibers of nylon 6, nylon 6,6, and nylon 6 copolymers to form a staple multifilament were tested for changes in yarn length (corresponding to fabric dimension) when the sample is wet. It was found that samples containing only nylon 6, nylon 6,6, and nylon 6 copolymers exhibited a dimensional change or length change of 1 to 2 percent, depending on fabric construction. In contrast, this dimensional change was minimized (i.e., near zero) when blends of nylon 6,10 staple were used to prepare the yarn.

In certain embodiments, the fabrics disclosed herein display significantly lower pilling as compared to otherwise equivalent PET based fabrics. Moreover, it was surprisingly found that fabrics formed from the nylon 6,10 materials disclosed herein displayed lower pilling than otherwise equivalent nylon 6,6 fabrics. In particular, the pilling may be determined by ASTM D4970 and ASTM D4966-98, which is an oscillating test where fabric samples are mounted flat and rubbed in a figure eight like motion using a piece of worsted wool cloth as the abradant. The number of cycles that the fabric endures before it shows objectionable change in appearance like a particular pilling level (AATCC standard cards) is measured. Multiple factors influence pilling and thus similar length, crimp level, dpf, and fabric construction were used for side by side comparison of the nylon 6,10 and comparative samples. The same tests were used to measure fabric wear by observing the number of cycles the fabric samples could endure before a hole is formed. Fabrics made with nylon 6,10 showed a 20 to 50 percent increase in the number of cycles to failure versus otherwise equivalent PET and nylon 6,6 samples.

In certain embodiments, the fabrics disclosed herein display a softer hand as compared with nylon 6,6 and PET fabrics made with same yarn and fabric specifications. In some embodiments, the fabrics have a low flexural modulus, as compared to other equivalent fabrics made from nylon 6,6 or PET. Additionally, the fabrics disclosed herein may display further improvements in smoothness, which can be determined by the coefficient of friction/fiber to fiber friction, as measured by ASTM D3412, “Standard Test Method for Coefficient of Friction, Yarn to Yarn”.

In certain embodiments, the fabrics disclosed herein may display reduced static build-up versus equivalent PET based fabrics, as measured by Static Half Life, ASTM D4496-“Standard Test Method for D-C Resistance or Conductance of Moderately Conductive Materials”. Traditionally, PET based fabrics receive an antistatic treatment. Thus, utilizing the filaments disclosed herein may eliminate the need for this additional manufacturing step.

Regarding moisture uptake, traditional nylon 6 and nylon 6,6 fabrics display greater moisture uptake relative to polyester based fabrics. However, as discussed herein, polyester fabrics suffer from decreased comfort (e.g., abrasion) and increased static. Moreover, the absorption of water, such as by nylon 6,6, which can absorb up to 2.5 percent, by weight, may have two effects: dimensional change in fabric (i.e., fabric looks wrinkled as fabric increases its dimensions) and change in the color of fabric causing an unsightly look.

AATCC Test Method 195-2009 was utilized to study moisture wicking of the fabrics disclosed herein. Surprisingly, the nylon 6,10 fabrics had near equal water wicking ability as compared to equivalent polyester fabrics.

A taber test to color change showed that the nylon 6,10 fabrics disclosed herein exhibit 40 percent or higher cycles as compared to PET and nylon 6,6 fabrics.

ASTM D3787-16 “Standard Test Method for Bursting Strength of Textiles—Constant-Rate-of-Traverse (CRT) Ball Burst Test” was utilized. Test results showed comparable or superior results to nylon 6,6 and PET fabrics with similar yarn and fabric specification.

In certain embodiments, garments made from these fabrics are provided. For example, the garments may be undergarments, socks, shirts, pants, shoe inserts, or other known apparel types. In some embodiments, a body facing surface of the item of apparel is substantially formed from the nylon 6,10 filaments described herein. For example, the body facing/contacting surface may be of fabric rich in 6,10 yarn in order to achieve odor reduction and the opposite fabric face could be a mix of yarns.

Thus, the present disclosure allows for the manufacture of nylon based yarns and fabrics that display one or more of the beneficial properties of traditional nylon materials (e.g., lower coefficient of friction, reduced wear, lower propensity to generate static, and improved feel) while also displaying a resistance to wrinkling and moisture uptake that is typical of polyester based materials. Further, the nylon based yarns and fabrics disclosed herein solve unmet needs around wrinkle resistance, reduced skin-abrasion, moisture uptake, and odor control.

### EXAMPLES

Embodiments of the present disclosure may be better understood by reference to the following examples.

### Example 1: Nylon Yarns

Nylon 610 was produced in a typical 3 vessel process. First, a nylon 610 salt mix, consisting of a stoichiometric balance of hexamethylene diamine and sebacic acid was prepared in a mix tank with water. Next, this salt solution was concentrated under conditions just above boiling in an evaporator vessel, and was polymerized in a reactor following typical heating under pressure followed by vacuum finishing. The resulting resin was pelletized, dried to a moisture level of 0.06-0.10 wt. % water, and packed for fiber spinning. The nylon 610 was prepared to have a relative viscosity (RV) of 58 and a carboxylic acid end group concentration of 40 meq/Kg.

Next, a portion of the nylon 610 pellets was converted to a partially-oriented-yarn (POY) on standard machinery. The target denier and filament count were 100 and 68, respectively. TiO₂ was added to the masterbatch using same nylon 610 as carrier to achieve semi-dull look.

Next, the partially-oriented yarn was converted to a textured yarn on standard machinery. The filament was textured using air jet texturing process at conditions used for N6, and the resulting textured yarn had a denier of 70 with 68 filaments. The textured yarn was converted to circular double knit interlock fabric with a spec weight of 130 gsm, which was then heatset at Nylon 6 conditions.

Yarns made of Nylon 66 and PET were used to create fabrics with same weight and fabric constructions.

### Example 2: Physical Characterization

In one experimental example, a nylon 6,10 material was manufactured in accordance with the above-described methods and in the absence of catalyst. The crystallization peak of the material was measured on a differential scanning calorimeter (DSC). In particular, a heat-cool-heat cycle was conducted from room temperature to 300° C. at a 20° C./min scan rate. Typical N6,10 (i.e., nylon 6,10 produced through traditional methods) shows an onset of crystallization at 189° C., peak crystallization at 183° C., and an end of crystallization at 176° C. However, surprisingly, the modified nylon 6,10 produced according to the methods described herein showed a shifted crystallization profile, relative to traditionally manufactured nylon 6,10. In particular, the modified nylon 6,10 showed an onset of crystallization at 189° C., peak crystallization at 179° C., and an end of crystallization at 171° C. The shift in peak and end temperatures indicate slow crystallization, which is believed to contribute to the improved processing character of these nylon materials, as is described in further detail below.

Next, the nylon 6,10 material was held in a capillary rheometer for 90 minutes. The melt viscosity at 100 s−1 was measured every 10 minutes. The modified nylon 6,10 material exhibited a viscosity increase of less than 30 percent over time, as compared to typical commercial nylon, which exhibited a rise in viscosity of 60 to 100 percent over time. Thus, the presently described nylon 6,10 materials display a relatively stable melt viscosity over time when held at melt temperature.

Next, nylon 6,10 and comparative nylon 6,6 yarns were soaked in water, followed by towel drying and hang dry in a conditioned atmosphere (21±1° C., 70±2° F.) and 65±2% relative humidity for 1 hour. Then the slightly moist samples were heated in a DSC at 20° C./min. The energy associated with water evaporation was calculated and found to be 75% lower for nylon 6,10 versus nylon 6,6. Thus, the nylon 6,10 samples will show improved wrinkle resistance and color uniformity as compared to nylon 6,6 fabrics.

### Example 3: Friction Testing

Yarns were prepared and tested according to ASTM D3412, a standard test method for yarn to yarn coefficient of friction testing, sometimes referred to by those of skill in the art as the Capstan test. This method was used to measure the relative difference between fiber to fiber friction for a control PET sample, and two nylon 6,10 samples made in Example 1 above.

The pretension for each yarn sample was set to 1/10^{th} of the denier, and the static friction, dynamic friction, and Scroop results were measured. The average static friction, dynamic friction, and Scroop results are shown in Table 1 below:

TABLE 1
Friction Testing Results

| | | | | Average | |
|---|---|---|---|---|---|
| | | | Average | Dynamic | |
| | | | Static Friction | Friction | Average |
| Sample | Denier | Filaments | Force (g) | Force (g) | Scroop (Δ) |
| PET | 70 | 72 | 16.3 | 13.8 | 2.5 |
| N610 | 70 | 68 | 14.7 | 13.5 | 1.2 |
| N610 | 40 | 34 | 8.4 | 7.3 | 1.1 |

Notably, the N610 samples exhibited a static friction force well below that of PET for nearly the same yarn type, even though the N610 samples did not have a lubricant coating, which would have provided the optimum finish for this testing. Without intending to be bound by any particular theory, it is believed that both static and dynamic friction forces could be further decreased by applying such lubricant coating.

The Scroop value, or the difference between the average static friction force and average dynamic friction force, gives an indication of hand feel. As can be seen from Table 1 above, the Scroop value of the N610 samples is substantially lower than that of the tested PET samples. This indicates that the N610 samples exhibit a superior hand or silky feel as compared to PET.

An ASTM D4966 test was run on the N610 fabric, using 9,600 Martindale abrader cycles with fabric to fabric contact. Surprisingly, this circular double knit interlock fabric did not show any wear following this testing.

### Example 4: Microbial Activity

Next, jester-style shirts, wherein each half of the shirt was made of a different fabric, were made from the filaments described above. In these tests, the right half of the shirts was made with N610, while the left sides of the shirts were made with either PET, N6, or N66 fibers. Subjects wore these shirts for 8-12 hours in a day, including 15-30 minutes of brisk activity. Following this time period, the shirts were cut in half, separating the side made from N610 from the other side of the shirt. Each half of the shirts was then lightly sprayed with a water mist, stored in a bag and exposed to a temperature of 95° F. for 36 hours in the absence of light, to accelerate microbial growth on the fabric.

Next, Bioinspired Solutions test method MP-S1-202 was performed to gently dislodge any bacteria from the fabric. Next, Bioinspired Solutions test method MP-S1-203 was performed to identify and quantify the bacteria present in each of the fabric samples. The types of bacteria found on these garments included enhydrobacter aerosaccus, micrococcus luteus, and corynebacterium jeikeium. However, the concentrations of each of these bacteria on the garments were found to be at least 50% lower on the Nylon 610 fabric than on the PET or N66 fabrics, and were in some instances found to be as much as 90% to 95% lower on the Nylon 610 fabric than on the PET or N66 fabrics.

Without wishing to be bound by any particular theory, it is believed that the N610 compositions described herein, and filaments, yarns, fabrics, or personal or medical articles made therefrom, may exhibit antibacterial properties. Specifically, without wishing to be bound by any particular theory, it is believed that the N610 compositions described herein, and filaments, yarns, fabrics, or personal or medical articles made therefrom, may serve to effective kill gram-negative bacteria.

Without intending to be bound by any particular theory, it is believed that N610 polymers having more carboxylic acid end groups than amino end groups may exhibit particularly improved microbial activity. Specifically, it is believed that N610 compositions with more carboxylic acid end groups exhibit less microbial activity than N610 compositions with more amino end groups.

### Example 5: Dry Time and Permeability

Next, fabrics were produced from 1 dpf, 70 denier PET, N66, or N610 yarns. Each fabric had a weight of about 135 gsm. These fabrics were wetted and subsequently dried on a heated plate, according to procedure AATCC 201. The air permeability and air drying time of these fabrics were also tested. Specifically, the air permeability of these fabrics was tested using ASTM D737. The air drying time was tested by placing the water-soaked fabric samples on a frame with air flowing through the fabric. The incoming humidity of the air before contacting the fabric and the humidity of the air after contacting the fabric were measured over time. The fabrics were considered dry when the humidity of the incoming air before contacting the fabric was the same as the outgoing air after contacting the fabric. The results of these tests are shown in Table 2 below:

TABLE 2
AATCC 201 Dry Times

| Fabric | AATCC 201 Dry Time | ASTM D737 Air | Air Dry Time |
|---|---|---|---|
| Type | (minutes) | Permeability (CFM) | (minutes) |
| PET | 6.2 | 381 | 35.8 |
| N66 | 7.3 | 380 | 29 |
| N610 | 6.0 | 405 | 24 |

As can be seen from Table 2, the N610 fabric dried significantly more quickly than the N66 fabric, and even dried more quickly than the PET fabric, when measured using the AATCC 201 test method. The N610 fabric also had significantly higher air permeability than the PET or N66 fabrics, and a significantly shorter air dry time. This suggests that the N610 fabric may be particularly suitable for athletic garments, or other quick dry applications.

It will be apparent to those skilled in the art that various modifications and variations can be made to the present disclosure without departing from the spirit and scope of the invention. Thus, it is intended that the present disclosure cover the modifications and variations of this invention provided they come within the scope of the appended claims and their equivalents.

1. A method of making a nylon 6,10 material, comprising:
conducting a polymerization reaction to obtain a nylon 6,10 material having a relative viscosity of from about 40 to about 70.

2. The method of claim 1, wherein the polymerization is conducted in the absence of any catalyst.

3. The method of claim 1, wherein conducting the polymerization reaction comprises reacting sebacic acid and hexamethylenediamine.

4. The method of claim 1, wherein the nylon 6,10 material has a crystallization peak range of at least about 15° C.

5. The method of claim 1, wherein the nylon 6,10 material displays an onset of crystallization at a temperature of about 189° C.

6. The method of claim 1, wherein the nylon 6,10 material displays a peak crystallization at a temperature of about 179° C.

7. The method of claim 1, wherein the nylon 6,10 material displays a crystallization end point at a temperature of about 171° C.

8. The method of claim 1, wherein the nylon 6,10 material displays a viscosity increase of less than thirty percent over time when held at melt temperature.

9. The method of claim 1, wherein carboxylic acid end groups exceed amino end groups in the nylon 6,10 material.

10. The method of claim 1, wherein a carboxylic acid end group level exceeds 30 meq/Kg in the nylon 6,10 material.

11. A nylon 6,10 material having a relative viscosity of from about 40 to about 70.

12. The nylon 6,10 material of claim 11, wherein the nylon 6,10 material has a crystallization peak range of at least about 15° C.

13. The nylon 6,10 material of claim 11, wherein the nylon 6,10 material displays an onset of crystallization at a temperature of about 189° C.

14. The nylon 6,10 material of claim 11, wherein the nylon 6,10 material displays a peak crystallization at a temperature of about 179° C.

15. The nylon 6,10 material of claim 11, wherein the nylon 6,10 material displays a crystallization end point at a temperature of about 171° C.

16. The nylon 6,10 material of claim 11, wherein the nylon 6,10 material displays a viscosity increase of less than thirty percent over time when held at melt temperature for 60 minutes.

17. The nylon 6,10 material of claim 11, wherein carboxylic acid end groups exceed amino end groups in the nylon 6,10 material.

18. The nylon 6,10 material of claim 11, wherein a carboxylic acid end group level exceeds 30 meq/Kg in the nylon 6,10 material.

19. A method of making a filament, comprising:
spinning the nylon 6,10 material of claim 11 to form a filament.

20. A filament, comprising:
a main structural component that comprises the nylon 6,10 material of claim 11.

21. The filament of claim 20, wherein the filament exhibits antibacterial surface properties that resist the presence of odor-causing bacteria comprising Staphylococcus, and/or Propionibacterium acnes, Micrococcus.

22. The filament of claim 20, wherein the filament has a denier per filament of from about 0.7 dpf to about 12 mil.

23. A filament, comprising:
a main structural component that comprises a nylon material selected from nylon 6,10, nylon 6,12, nylon 6,18, nylon 11, nylon 12, and copolymers of nylon 6,10, nylon 6,12, nylon 6,18, nylon 11, and nylon 12,
wherein the filament has a denier per filament of from about 0.7 dpf to about 4 dpf, and
wherein the filament displays a reduction of microfiber generation, by weight, over 30 wash cycles, as compared to an otherwise equivalent polyethylene terephthalate (PET) filament.

24. The filament of claim 23, wherein the reduction of microfiber generation is from about 50 percent to about 99 percent.

25. A fabric, comprising:
a plurality of filaments,
wherein at least a portion of the filaments are the filaments of claim 23.

26. The fabric of claim 25, wherein the fabric has a dry time which is at least about 3% less than that of a comparative PET or N66 fabric, when measured according to AATCC 201.

27. The fabric of claim 25, wherein the fabric has an air dry time which is at least about 20% less than that of a comparative PET or N66 fabric.

28. The fabric of claim 25, wherein the fabric has an air permeability which is at least about 6% greater than that of a comparative PET or N66 fabric.

29. The fabric of claim 25, wherein the fabric exhibits a concentration of one or more of enhydrobacter aerosaccus, micrococcus luteus, and corynebacterium jeikeium are at least 50% lower than that on a comparative PET or N66 fabric, when measured according to MP-S1-202 and MP-S1-203.

30. The fabric of claim 25, wherein the plurality of filaments are staple filaments, and wherein the dimensional change when wet of the fabric is less than 1 percent, per length.
